(19) United States
(12) Patent Application Publication
(10) Pub. No.: US 2016/0076349 A1
(43) Pub. Date: Mar. 17, 2016

(54) METHOD AND APPARATUS FOR ENHANCING THE PRODUCTIVITY OF WELLS

(71) Applicants: Darrell Ray DOUS, Sherwood Park (CA); Scott Allan SELTENRICH, Rimby (CA); Anthony MANNING, Calgary (CA); John Edward HALAT, Sylvan Lake (CA)

(72) Inventors: Darrell Ray DOUS, Calgary (CA); Scott Allan SELTENRICH, Rimby (CA); Anthony MANNING, Calgary (CA); John Edward HALAT, Sylvan Lake (CA)

(21) Appl. No.: 14/784,515

(22) PCT Filed: Apr. 16, 2014
(86) PCT No.: PCT/CA2014/050381

§ 371 Date: Oct. 14, 2015

Related U.S. Application Data
(60) Provisional application No. 61/812,768, filed on Apr. 17, 2013.

(51) Int. Cl. E21B 43/26; C09K 8/80; E21B 43/267; C09K 8/66

(52) U.S. Cl. CPC E21B 43/26; C09K 8/665; C09K 8/80; E21B 43/267

(57) ABSTRACT

The invention relates to a hydrocarbon production stimulation method which can be used in new reservoirs and in reservoirs that have been previously fractured (e.g., by hydraulic fracturing) or that have naturally occurring fractures. A zone of the wellbore is isolated, a liquid chemical rock splitting agent composition is injected into the isolated zone and then forced into the subterranean formation with an inert compressed gas, the chemical rock splitting agent is permitted to expand and harden, and the agent is then removed from the formation. A proppant may be used to hold fractures open.

### FIELD

The invention described herein relates to the recovery of hydrocarbons from geological zones containing source rock. More specifically the invention relates to a method of producing fluid-conductive fractures within a rock formation for the recovery of fuels such as oil and gas therefrom that uses chemical rock splitting agents.

### BACKGROUND

There are a number of situations in which important economic benefit can be obtained by opening up subterranean pathways which are capable of conducting the flow of liquids and gases. Such pathways have been extensively used to increase the production of oil and gas from wells drilled into oil-containing and gas-containing formations. Such formations are often stimulated by fracturing treatments usually to produce an increase in the flow of oil or gas to the well.

In the past, explosives lowered into wellbores in the formation were used to fracture rock and thereby stimulate the production of wells. The technique known as hydraulic fracturing has largely replaced explosive stimulation techniques. In hydraulic fracturing, a liquid is pumped into an isolated section of a wellbore to a high enough pressure to create or enhance one or more pathways, or “fractures” in the subterranean formation. Enhancing a fracture generally involves extending or enlarging a natural or pre-existing fracture in the formation. Further liquid may pumped in to enlarge the fracture after the initial fracture. These fractures generally increase the permeability of that portion of the formation. Wells may also be fractured by injection of inert gases, often nitrogen, into a reservoir.

The fluids used in hydraulic fracturing may include additives such as acids, to dissolve rock and minerals; proppants such as coarse sand, that become embedded in the fractures to hold them open; gelling agents to thicken the fluid and thereby suspend the proppants; breakers, to allow delayed breakdown of the gel; surfactants to increase the viscosity of the fracture fluid, corrosion inhibitors, friction reducers, scale inhibitors and pH adjusters.

While hydraulic fracturing has clear economic benefits derived from the extraction of vast amounts of formerly inaccessible hydrocarbons, the process can impact the environment, by contaminating ground water, impacting air quality, the migration of gases and hydraulic fracturing chemicals to the surface, surface contamination from spills and flowback, and the health effects of these. Further, hydraulic fracturing uses tremendous amounts of fresh water and leaves an environmental footprint for years to come. For these reasons hydraulic fracturing has come under scrutiny internationally, with some countries suspending or banning it.

Calcium oxide (CaO)-based chemical rock splitting agents, also known as expansive cements, “non-explosive demolition agents”, expansive mortars, expansive concretes and non-explosive cracking agents, have been widely used to generate fractures in rocks and concrete structures. When water is added to these agents calcium oxide reacts with the water and converts to calcium hydroxide [CaO+H₂O=Ca(OH)₂], expanding 2 times in volume with the generation of heat (an exothermic reaction). The cracking of the rock may be the result of thermal stress induced by the heat in combination with the expansive stress due to the volume increase. As a result of these stresses, which increase with time, the object to be cracked undergoes a process of crack initiation, crack propagation and an increase in crack width.

Chemical rock splitting agents capable of expanding by hydration are available commercially, for example, BRISTAR® (available from Taiheiyo Materials Corporation.), CRACKAMITE® (available from Hydraulics and Pneumatics), CRACKAG® (available from Sino-Expansion Co., Ltd) and SPLITSTAR® (available from Xiamen Bestlink Factory Co., Ltd.). By adding suitable fillers e.g. inert materials, to the mixture, the ultimate expansive force can be controlled to a desired value. Many chemical rock splitting agents have an expansive stress of 30N/mm².

Chemical rock splitting agents are environmentally friendly. They are safe to use and require no special license or expertise to use them. They are noise and vibration free, and are therefore quiet to use.

U.S. Pat. No. 7,909,099 describes an oil product stimulation method that can be used in reservoirs with fractures resulting from fracturing procedures and in reservoirs with naturally-occurring fractures. In this method, a material which expands while hardening or setting is injected into the near-wellbore region of a cased well, into the space between the casing and the reservoir, and the wellbore is then perforated. After perforation the reservoir may be hydraulically fractured.

### SUMMARY

In one aspect the invention is a method for enhancing the productivity of a fractured subterranean formation that includes:

a) isolating a zone of a wellbore that has been drilled into the subterranean formation;

b) preparing a liquid chemical rock splitting agent composition and injecting it into the isolated zone and then into the subterranean formation;

c) allowing the chemical rock splitting agent to expand and/or harden; and

d) removing the agent from the formation.

In one embodiment, the chemical rock splitting agent is injected into the isolated zone and subterranean formation using an inert compressed gas. In another embodiment, the chemical rock splitting agent is injected into the isolated zone and subterranean formation using a column of fluid.

In one embodiment, the wellbore is a cased wellbore that has been perforated. In one embodiment the liquid chemical rock splitting agent is injected into the wellbore inside the casing and the liquid is then forced through the perforations in the casing into the subterranean formation.

In another embodiment the wellbore is an openhole wellbore.

In one embodiment, the liquid chemical rock splitting agent is injected into the wellbore with a coil mounted fracturing tool.

In one embodiment, the liquid chemical rock splitting agent is forced into the subterranean formation using a coil mounted fracturing tool.

In one embodiment, a proppant is added to the liquid chemical rock splitting agent composition before it is injected into the wellbore.

In another embodiment, a proppant is injected into the wellbore after the liquid chemical rock splitting agent composition has expanded and hardened.

In one embodiment, the agent is removed from the formation with an acid wash.

In another embodiment, the agent is removed from the formation with a caustic wash.

In another aspect, the invention is the use of a liquid chemical rock splitting agent composition to fracture a subterranean formation around an openhole wellbore.

In another aspect, the invention is the use of a liquid chemical rock splitting agent composition to fracture a subterranean formation around a cased and perforated wellbore, wherein the liquid chemical rock splitting agent is injected inside the casing and then forced through the perforations in the casing, into the subterranean formation.

In one embodiment, the liquid chemical rock splitting agent composition is used in an isolated zone of the wellbore.

In one embodiment, the zone of the wellbore is isolated using a coil mounted fracturing tool.

In one embodiment, the liquid chemical rock splitting agent composition is injected into the subterranean formation using a compressed gas. In another embodiment the liquid chemical rock splitting agent composition is injected into the subterranean formation using a column of fluid.

In one embodiment, a proppant is used, in addition to the liquid chemical rock splitting agent composition.

### DETAILED DESCRIPTION

Described herein is a method and apparatus for fracturing subterranean rock formations and for enhancing the production of oil and gas from conventional and unconventional reservoirs. The method is particularly well-suited for use in restimulating existing conventional oil and gas wells that have fractures resulting from previous fracturing procedures or that have naturally occurring fractures. The number of conventional oil and gas wells that have been drilled in North America to date is about 7 to 10 million wells. The method described herein may enhance the productivity of these pre-existing wells.

The method is also well-suited for use in stimulating production in unconventional reservoirs that have fractures resulting from previous fracturing procedures, or that have naturally occurring fractures. The method may also be used in new reservoirs.

As compared to hydraulic fracturing, the method described herein is environmentally friendly, lessens the amount of ground disturbance, decreases fresh water usage, lessens noise pollution, eliminates well communication, and decreases contaminants in ground water and fresh water zones.

Generally, the method includes the following steps:

a) isolating a portion of a wellbore that has been drilled into the subterranean formation;

b) preparing a liquid chemical rock splitting agent composition and injecting it into the isolated zone in the wellbore and then into the subterranean formation;

c) allowing the chemical rock splitting agent to expand and/or harden; and

d) removing the agent from the formation.

The method may be practiced in a cased, uncased, openhole, horizontal, non-vertical, vertical, deviated, etc., wellbores.

The method is practiced on wells that are previously fractured. A “previously fractured well” as used herein means a well that has fractures resulting from previous fracturing procedures (e.g., hydraulic- or gas-fracture), or a well that has naturally occurring fractures.

In a preferred embodiment, fracturing is performed in cased wellbores and the zones to be fractured are accessed by perforating the casing and cement around the casing at those locations. The perforations of the casing and cement provide for fluid communication between the wellbore and the target zone in the subterranean formation. Methods and tools for perforating casing, such as perforating guns, chemical cutters, water jet cutters and/or mechanical cutters are well known to those of skill in the art.

The chemical rock splitting agents useful in the present method have an expansion degree that is sufficient to apply pressure to existing fractures in the wellbore walls, while hardening and setting, to open the existing fractures and thereby allow fluid passage. Rock splitting agents useful in the present method preferably comprise predominantly an expansive agent such as calcium oxide (CaO), magnesium oxide (MgO), ferrous oxide (FeO) and sulpho-aluminate, with CaO being preferred. However, other types of agents that expand while hardening, such as polymers, are included in the methods described herein if they would provide sufficient pressure on hardening to further fracture a formation.

Examples of chemical rock splitting agents useful in the present method are BRISTAR® (available from Taiheiyo Materials Corporation.), CRACKAMITE® (available from Hydraulics and Pneumatics), CRACKAG® (available from Sino-Expansion Co., Ltd) and SPLITSTAR® (available from Xiamen Bestlink Factory Co., Ltd.); DEXPAN® (available from Dexpan Canada), ECOBUST® (available from Ecobust International Inc.), SYLENTMITE® (available from Home Depot) and PROSTAR® (available from Xiamen Prodemo Imp. & Exp. Co., Ltd.).

The amount of expansive agent used may vary depending on the characteristics of the subterranean formation in which the chemical rock splitting agent is to be used. For example the chemical rock splitting agents may contain from 60% to 100% CaO and from 0 to 2% MgO.

The characteristics of the chemical rock splitting agents may be modified by other materials that have been added to the mixture, thus the ultimate expansive force and other qualities of the chemical rock splitting agents can be controlled to a desired value. For example, BRISTAR chemical rock splitting agent is available in different types (BRISTAR 100, 150, 200, 300) that are used at different temperatures.

Chemical rock splitting agents may include other additives for example: Silicon dioxide (SiO₂), Aluminum Oxide (Al₂O₃), Ferric Oxide (Fe₂O₃), Sulphur Trioxide (SO₃); Manganese Oxide; Sulphur; Potassium Oxide (K₂O); Sodium Oxide (Na₂O); Silica Vitreous; Aluminum Oxite, and organic compounds such as sulphonated melamine and naphthalenesulfonic acid, polymer with formaldehyde, sodium salt. Examples of useful amounts of these compounds are: SiO₂, 0 to 11%; Al₂O₃, 1.0 to 6%; Fe₂O₃, 0 to 5%; SO₃, 0 to 5%; manganese oxide, 0 to 2%; Sulphur, 0 to 2%; K₂O, 0 to 2%; Na₂O, 0 to 2%; Silica vitreous, 5 to 10%; Aluminum Oxite, 1 to 5% and 1% organic compounds. Again the amounts and types of additives used may vary depending on the characteristics of the subterranean formation in which the chemical rock splitting agent is to be used.

The expansion parameters may be promoted through the appropriate selection of the expanding material. The reaction conditions in a subterranean formation are usually determined by the geological properties specific to each formation. These may include, but are not limited to, the formation temperature and pressure, the formation fluid concentration and composition, and formation chemistry (e.g., rock composition, pH). The formation properties may affect the resultant expansion reaction, and the appropriate selection of the type of chemical rock splitting agent may be used to promote a specific reaction. One of ordinary skill in the art will be able to determine which type of chemical rock splitting agent should be used to achieve a desired results based on, for example the formation conditions and chemistry. The formation composition and chemistry may be determined from an analysis of the subterranean formation materials, for example, core samples and formation fluid.

Chemical rock splitting agents are generally provided in powder form that is to be mixed with water before use. Mixing of the water into the powder is done at the well site, and may take place in a mixing hopper. In most embodiments, the water and powder a mixed for 10 minutes before introducing the resultant mixture downhole. However the mixing time may be longer or shorter. In some embodiments an advantage of the instant method is that produced water, instead of fresh water, may be used in the preparation of the liquid chemical rock splitting agent.

The chemical rock splitting agent composition may further comprise a proppant to maintain fracture width for as long as possible. A proppant is a material such as grains of sand, ceramic, or other particulate that prevents the fractures from closing when the injection of the chemical rock splitting agent is stopped, or when the pressure on the agent is released, and/or when the agent is removed from the fractures. In a preferred embodiment, sand is used as a proppant for the formation. The propped fracture is permeable enough to allow the flow of formation fluids to the wellbore. The proppant may be added to the chemical rock splitting agent either before or after the chemical rock splitting agent is introduced into the subterranean formation.

The liquid chemical rock splitting agent may be designed to, or may comprise additives that are selected to optimize the hydration reaction [CaO+H₂O=Ca(OH)₂], with two objectives: (a) to maximize the conversion of CaO to Ca(OH)₂ and thereby reduce the amount of residual CaO that remains after the reaction is complete and (b) to minimize the amount of Ca(OH)₂ that is needed to be produced by the hydration reaction in order to obtain satisfactory levels of fracturing—i.e., to optimize Ca(OH)₂ crystal formation by the hydration reaction, so that less Ca(OH)₂ crystal is formed. For example, the size of the calcium oxide (CaO) particles in the mixture may affect the nature and extent of the reaction. Or, plasticizers (polysaccharides, polymers, salts), MgO, and alkali or alkaline borate may promote the formation of larger crystals of Ca(OH)₂ and therefore reduce the amount of Ca(OH)₂ that is needed to be produced by the hydration reaction.

The liquid chemical rock splitting agent may additionally comprise additives that are used in conventional fracturing processes, such as for example gelling agents, breakers, surfactants, corrosion inhibitors, friction reducers, scale inhibitors and pH adjusters.

The method disclosed herein requires the isolation of the portion of the wellbore that is to be treated with the chemical rock splitting agent.

Preferred for use in the methods described herein are coil mounted fracturing tool/systems that isolate a portion of a wellbore between upper and lower coil mounted fracturing cups or packers, and provide fluid to the isolated portion. These tools allow for selective isolation of downhole intervals for pinpoint stimulation treatments. Examples of such tools are the C2C™ selective stimulation straddle tool available from Trican Well Service, the MultiStim™ Cup Frac tool available from Logan Completion Systems Inc. or the M2 ISP™ inflatable straddle packer available from Weatherford International Limited.

If a coil mounted fracturing system is used in the method, the tool is lowered into the wellbore to a predetermined zone of interest and the zone to be fractured is isolated from neighbouring zones. The liquid chemical rock splitting agent is then pumped into the coiled tubing and compressed gas or fluid (e.g., water) is used to push it down the tubing and into the wellbore. A rubber retrievable or compressed paper pig can be used to separate the chemical rock splitting agent and the inert compressed gas and/or column of fluid which pushes the chemical rock splitting agent into the formation. The chemical rock splitting agent is forced into the formation and the gas and/or fluid remain behind the pig. Gases useful in the method are nitrogen (N₂), nitrogen dioxide (NO₂), carbon dioxide (CO₂) or argon. The pumps used to pump the slurry and gas are standard Cementing & Acidizing (C&A) units comprising piston style pumps such as triplex pumps or Quinn® pumps.

The pressure used to pump the gas into the formation is greater than the pressure in the isolated zone to be treated, and will be calculated based on well data.

In one embodiment, before the chemical rock splitting agent is injected into the wellbore, an acid wash is performed. In this step, a mixture of water with diluted acid, such as hydrochloric acid, is injected downhole. This serves to clear debris that may be present in the wellbore providing a clear pathway for the chemical rock splitting agent to access the subterranean formation.

In another embodiment, before the chemical rock splitting agent is injected into the wellbore, a cleaning run with a coil unit and a casing scraper is performed, to prepare the well. The casing scraper removes mill scale, burrs, cement sheath, mud cake and foreign matter from the inside wall of the casing, forming a smooth and clean surface for the proper seating of packers or cups of the coil mounted fracturing tool.

The chemical rock splitting agent is forced into the subterranean formation by using pressure from an inert compressed gas and/or column of fluid to force the agent into the cracks in the formation. The pressure used to inject the liquid agent into the formation may be above the fracture gradient of the rock, but it does not need to be. What is important is that the liquid agent is disposed in the existing fractures before it expands and sets/hardens.

Using a coil mounted fracturing system, the chemical rock splitting agent is injected into the formation by a standard Cementing & Acidizing (C&A) unit comprising piston style pumps such as triplex pumps or Quinn® pumps.

The liquid chemical rock splitting agent will expand and harden over a time period selected by the operator. Typically, the time required for the material to expand and harden is approximately 5 to 36 hours, however longer or shorter time periods may be appropriate depending on the circumstances. The lower the temperature in the formation, the longer will be the time for expansion and hardening to take place.

After the rock splitting agent has been permitted to expand and harden for the desired length of time, an acid wash or a caustic wash is performed using a conventional acid or non-conventional acid or caustic agent, preferably one that is environmentally friendly. The acid or caustic washes remove some or all of the filter cake, i.e. residue from the product application, prevent further erosion of the casing cement job if the well is cased and cemented, and clean out additional residue in the source rock material, all of which allow the hydrocarbons to flow more freely.

Examples of environmentally friendly, nonconventional acids or caustic compounds usable in the present method are: Enviro-Syn HFR (synthetic hydrofluoric acid replacement); Enviro-CSR (synthetic liquid caustic replacement); Enviro-Syn HCR (synthetic hydrocholoric acid replacement) or Enviro-Syn HSR (synthetic sulphuric acid replacement). These products are available (or will soon be available) from Fluid Energy Group Ltd.

Conventional acids include hydrofluoric acid (available from Eastern Chemicals), hydrochloric acid (available from ERCO Worldwide; Milton Chemicals Pvt. Ltd.; Emco Chemical Distributors Inc.) or sulphuric acid (available from Emco Chemical Distributors Inc.). Conventional caustic agents include caustic soda (NAOH, or lye; available from ERCO Worldwide, Emco Chemical Distributors Inc.).

Optionally a general chemical wash may be used to remove and/or dissolve the calcium hydroxide (CaOH) formed by the expanding and hardening of the chemical rock splitting agent.

### EXAMPLE

The following is a representative example of a field trial of the subject technology using in a cased well, using a coil-mounted fracturing tool.

A 1000 m abandoned gas well with perforations at 640 meters, in Viking sandstone, is characterized as follows:

a) A review of the logs by a Reservoir Professional Engineer to determine if the well is a viable candidate for the well expansion process is performed, along with a thorough review of the performance of the well. Reservoir viability, formation logs and porosity are all considered in this review.

b) If available a core sample is tested with the chemical rock splitting agent composition on surface, simulating the down hole temperature and pressure, to provide data for extrapolation to the amount of product and type of blend needed to best suit the formation. The surface testing will help to determine whether produced water or clean water can be used and or a proppant will be needed with an acid wash afterwards.

The chemical rock splitting agent comprises the following ingredients in powder form: SiO₂ 5.1 to 11%; CaO 75 to 97%; Fe₂O₃ 0.5 to 6%; Al₂O₃ 0 to 2%; MgO 0.5 to 5%; SO₃ 5 to 10%; Silica vitreous 5 to 10%; Aluminum oxite 1 to 5%; Dilron trioxide 1 to 5%. To this powder, H₂O will be added.

A static test of the well will be done prior deployment of the equipment to location.

The equipment used on location includes one or more of the following:

Coil tubing rig (capable of reaching the depths required);

Mixing hopper, ether static mounted on truck or separate;

Wire line truck;

Nitrogen unit capable of exerting 60 mpa of pressure;

Water truck, fresh or produced water depending on requirements;

Frac sand truck to provide proppant if needed;

Cementing & Acidizing (C&A) unit with small Quinn pump for pumping acid wash and sand, if needed; and

Well test equipment (pressure vessel and recorders)

The equipment is spotted on location and connected to the well.

If needed, a cleaning run with the coil unit and a casing scraper is performed, to prepare the well.

Once this is done the fracturing tool and isolation packers or cups are run into the hole and the zone to be fractured is isolated.

A nitrogen push is sent from surface to determine if the zone is capable of accepting or will accept the liquid chemical rock splitting agent, and also to provide the operator with an indication of the pressure that will be needed to push the liquid through the perforations in the casing into the zone of interest.

After a base line of pressure is set for the well, the chemical rock splitting agent powder is mixed with water or produced water on surface in the mixing hopper. An appropriate amount of H₂O may be 1.5 L/5 kg of powdered chemical rock splitting agent, however, depending on the exact type of chemical rock splitting agent used, and the formation conditions, the ratio of water to powder may be different. The powder and water are blended for preferably about 10 minutes. By this time point the hydration process has begun and it is important to introduce the liquid into the formation as soon as possible after it is mixed.

The liquid is pumped into the coil, immediately after mixing, with a conventional C & A unit and pushed downhole, for example using nitrogen gas. It is pushed into the wellbore in the isolated zone, followed by a nitrogen push that is adequate to force the liquid through the perforations of the casing and into the subterranean formation. It should take no more than 30 minutes to inject the liquid into the formation at 640 metres depth.

Depending on downhole temperature of the well, the rock splitting agent is allowed to expand and harden for 5 to 36 hours. During this time the pressure is maintained.

An increase or decrease of pressure during the reaction time may be noted. A decrease in pressure indicates that the source rock is being expanded. If needed, the pressure can be increased to compensate for the pressure drop.

If desired, sand or pumice as a proppant may be added during this process by using the C&A pumper on surface. The proppant may be added to the liquid chemical rock splitting agent before it is injected downhole, or it may be added afterwards.

After the agent has expanded and hardened, the treated zone is washed with an acidic compound, such as Enviro-Syn HCR® (synthetic hydrocholoric acid replacement) available from Fluid Energy Group Ltd. This will clean remnants of the reaction from the zone and allow for an enhanced recovery of the hydrocarbons in that zone.

The coil and tool are then pulled out and the well is tested to determine the value of the expansion for 3 days to a month.

1. A method for enhancing the productivity of a fractured subterranean formation that includes:
a) isolating a zone of a wellbore that has been drilled into the subterranean formation to form an isolated zone;
b) preparing a liquid chemical rock splitting agent composition and injecting it into the isolated zone and then into the subterranean formation;
c) allowing the chemical rock splitting agent to expand and/or harden; and
d) removing the agent from the formation.

2. The method of claim 1 wherein the chemical rock splitting agent is injected into the isolated zone and subterranean formation using an inert compressed gas.

3. The method of claim 1 wherein the chemical rock splitting agent is injected into the isolated zone and subterranean formation using a column of fluid.

4. The method of claim 1, wherein the wellbore is a cased wellbore that has been perforated.

5. The method of claim 4 wherein the liquid chemical rock splitting agent is injected into the wellbore inside the casing and the liquid is then forced through the casing into the subterranean formation.

6. The method of claim 1, wherein the wellbore is an openhole wellbore.

7. The method of claim 1, wherein the liquid chemical rock splitting agent is injected into the isolated zone with a coil mounted fracturing tool.

8. The method of claim 1, wherein the liquid chemical rock splitting agent is injected into the subterranean formation using a coil mounted fracturing tool.

9. The method of claim 1, wherein a proppant is added to the liquid chemical rock splitting agent composition before it is injected into the wellbore.

10. The method of claim 1, wherein a proppant is injected into the wellbore after the liquid chemical rock splitting agent composition has expanded and/or hardened.

11. The method of claim 1, wherein the agent is removed from the formation with an acid wash.

12. The method of claim 1, wherein the agent is removed from the formation with a caustic wash.

13. Use of a liquid chemical rock splitting agent composition to fracture a subterranean formation around an openhole wellbore.

14. Use of a liquid chemical rock splitting agent composition to fracture a subterranean formation around a cased and perforated wellbore, wherein the liquid chemical rock splitting agent is injected inside the casing and then forced through the perforations in the casing, into the subterranean formation.

15. The use of claim 13, wherein the liquid chemical rock splitting agent composition is used in an isolated zone of the wellbore.

16. The use of claim 15, wherein the zone of the wellbore is isolated using a coil mounted fracturing tool.

17. The use of claim 13, wherein the liquid chemical rock splitting agent composition is injected into the subterranean formation using an inert compressed gas.

18. The use of claim 13, wherein the liquid chemical rock splitting agent composition is injected into the subterranean formation using a column of fluid.

19. The use of claim 13, further comprising the use of a proppant.
